(19) United States
(12) Patent Application Publication
(10) Pub. No.: US 2006/0093812 A1
(43) Pub. Date: May 4, 2006

(54) Metallized opaque film

(75) Inventors: Dieter Scheidecker, Eltville (DE); Hutt Detlef, Heusweiler (DE); Yvonne Dupre, Kaiserslautern (DE)

Correspondence Address: CONNOLLY BOVE LODGE & HUTZ, LLP, P O BOX 2207, WILMINGTON, DE, 19899, US

(73) Assignee: Treofan Germany GmbH & Co. KG, Neunkirchen (DE)

(21) Appl. No.: 10/545,118

(22) PCT Filed: Feb. 20, 2004
(86) PCT No.: PCT/EP04/01664

§ 371 Date: Aug. 10, 2005

(30) Foreign Application Priority Data
Feb. 20, 2003 (DE) 103 07 133.4

(51) Int. Cl. B32B 15/08; B32B 27/32

(52) U.S. Cl. 428/349; 428/910; 428/461; 428/523; 264/173.19; 264/83

(57) ABSTRACT

The invention relates to metallized, biaxially oriented opaque polypropylene multilayer film comprising at least three layers consisting of a base layer, a first metallized covering layer, and of a second sealable covering layer on the opposite side. The first covering layer contains at least 80% by weight of a propylenelethylene copolymer, which has an ethylene content of 1.2 to <2.8% by weight and a propylene content of 97.2 to 98.8% by weight, a melting point ranging from 145 to 160° C., and a melting enthalpy ranging from 80 to 110 J/g. The first covering layer has a thickness of at least 4 ?m and the base layer contains vacuoles. The thick covering layer can also be formed from a combination consisting of an intermediate layer with a thin covering layer.

The present invention relates to a metallized opaque polypropylene film and its use in laminates, as well as a method for manufacturing pouch packages from these laminates.

Biaxially oriented polypropylene films (boPP) are currently used as packaging films in greatly varying applications. Polypropylene films are distinguished by many advantageous usage properties such as high transparency, gloss, barrier to water vapor, good printability, rigidity, piercing resistance, etc. In addition to the transparent films, opaque polypropylene films have been developed very successfully in past years. The special appearance (opacity and degree of whiteness) of these films is especially desirable for certain applications. In addition, opaque films offer a higher yield to the user because of the reduced density of these films.

In spite of these manifold favorable properties, there are still areas in which the polypropylene film must be combined with other materials in order to compensate for specific deficits. In particular for bulk products which are sensitive to moisture and oxygen, polypropylene films have not been successful until now as the sole packaging material. For example, in the field of snack packaging, both the water vapor barrier and also the oxygen barrier play a decisive role. With water absorption of only 3%, potato chips and other snack items become so sticky that the consumer finds them inedible. In addition, the oxygen barrier must ensure that the fats contained in the snack items do not develop a rancid taste through photooxidation. These requirements are not fulfilled by polypropylene film alone as the packaging material.

The barrier properties of polypropylene films having a vacuole-containing base layer are even more problematic, since in these types of films the vacuoles in the base layer additionally impair the water vapor barrier. For example, the water vapor barrier of a transparent biaxially oriented polypropylene film of 25 μm is approximately 4.4 g/m²*day at 38° C. A comparable value is only achieved in an opaque film having vacuole-containing base layer from a thickness of 35 μm. The oxygen barrier is completely insufficient for many applications both in transparent and in opaque polypropylene films.

Improving the barrier properties of boPP by metallization, by which both the water vapor permeability and also the oxygen permeability are significantly reduced, is known. Opaque films are typically not used in metallization, since their barrier is significantly worse without metallization than that of a transparent film. The barrier of the metallized films is better the better the barrier of the base film before the metallization is. For example, the oxygen permeability of a transparent 20 μm boPP film may be reduced through metallization and lamination with a further 20 μm transparent film to approximately 40 cm³/m²*day*bar (see VR Interpack 99 Special D28 “Der gewisse Knack [the special snap]”). Naturally, the special appearance of the opaque films no longer plays a role after metallization, since the metal coating is opaque and covers the appearance of the film. Therefore, opaque films do not offer any advantages as a substrate for metallization.

In applications for especially sensitive products, even the barrier of the metallized boPP films is insufficient. In such cases, the lamination of a substrate with an aluminum film is preferred. This packaging is much more complex and costly than composites made of metallized boPP films, but it offers an outstanding oxygen barrier because of the lamination with the high-density aluminum film. For example, laminates of this type having aluminum film are used for pouch soups and ready sauces (e.g., Maggi-Fix products) and similar powdered bulk products, which must be protected especially effectively from light and oxygen because of the high fat content and the large surface area of the powder.

An additional problem in a pouch package for powders of this type is the contamination of the seal area. To manufacture the pouch package (four-edge sealing), three edges are first sealed and a pouch open on top is thus manufactured. The pouch is then filled with the powder, dust of the powder also settling in the area of the fourth seal seam. The seal of the areas thus contaminated is significantly impaired. In the past, this problem could only be solved by laminating the particular composite with a special seal film. Therefore, current composite materials for powders of this type comprise a special seal film, which seals even in the event of contamination, and an aluminum film, which ensures the barrier, as well as further components if necessary.

In some applications, boPP films are also metallized only in consideration of the visual impression. In this case, the impression of a high quality package is to be given to the consumer, without a better barrier actually existing. In these cases, the requirements for the metallized film are comparatively non-critical. The metallized film must only have a uniform appearance and adequate metal adhesion.

DE 39 33 695 describes a non-sealable film made of a base layer made of polypropylene and at least one covering layer, which is synthesized from a special ethylene-propylene copolymer. This copolymer is distinguished by an ethylene content of 1.2 to 2.8 weight-percent and a distribution factor of >10 and a melting enthalpy of >80 J/g and a melt flow index of 3 to 12 g/10 minutes (21.6 N and 230° C.). According to the description, the properties of the copolymer must be kept within these narrow limits to improve the printability and the visual properties. This publication relates overall to transparent films.

The present invention is based on the special object of providing a pouch package for powdered bulk products which protects the bulk products from moisture and oxygen especially well and which simultaneously has an appealing printed appearance from the outside.

It is additionally the object of the present invention to provide a metallized film having outstanding sealing properties, which is simultaneously to have outstanding barrier properties, particularly in relation to oxygen and water vapor, after the metallization. Of course, the typical usage properties of the film in regard to its use as a laminate component must also otherwise be retained. The film is still to have good processability, for example.

The object on which the present invention is based is achieved by a metallized, biaxially oriented opaque polypropylene multilayered film which comprises a vacuole-containing base layer and at least one covering layer, the first covering layer containing at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g, and the first covering layer having a thickness of 4 l μm and being metallized on its surface.

The object is also achieved by a metallized, biaxially oriented opaque polypropylene multilayered film, which comprises a vacuole-containing base layer and at least one first intermediate layer and a first covering layer on the outer side of the first intermediate layer, the first covering layer and the first intermediate layer each containing at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g, and the first covering layer having a thickness of 0.5 μm and the first intermediate layer having a thickness of at least 3.5 μm and the film being metallized on the outer surface of the first covering layer.

The object is also achieved by laminates which are manufactured from these films.

As defined in the present invention, the base layer is the layer of the film which makes up more than 50%, preferably more than 65% of the total thickness of the film. Intermediate layers are layers which lie between the base layer and a further polyolefin layer. Covering layers form the external layers of the non-metallized coextruded film. Covering layers may be applied directly to the base layer. Furthermore, there are embodiments in which the covering layers are applied to the intermediate layer(s) of the film.

The present invention is based on the known metallized transparent coextruded films, which are known to have the required good barrier properties. It has been found that these known metallized films having transparent polyolefin layers may not be used advantageously for pouch packages, since the sealing properties are insufficient, in particular, contaminants due to the powdered bulk products significantly impair the quality of the seal seam. Different modifications of the coextruded seal layer have been investigated in the framework of the present invention. However, the object has not been able to be satisfactorily achieved in this way. Surprisingly, it was found that the sealing properties may be improved by using an opaque base layer having vacuoles (instead of a transparent base). Using a vacuole-containing base layer, the quality of the seal seam was impaired significantly less due to powder contaminants. However, it has also been shown that the barrier of the film (even after metallization) was simultaneously impaired by this measure in such a way that as a result acceptable quality could not be implemented for the pouch package. Surprisingly, the barrier impaired by a vacuole-containing base layer could be compensated for through a modification of the layer of the film to be metallized. It has been found that the film having an opaque base layer has an outstanding barrier after the metallization if the layer to be metallized has a thickness of at least 4 μm and is synthesized from the propylene-ethylene copolymer having low ethylene content, defined in greater detail in Claims 1 and 2.

This opaque layer to be metallized may be implemented through a single covering layer of appropriate thickness on the opaque base layer. An intermediate layer may also advantageously be combined with the covering layer, the total thickness of intermediate and covering layers also to have a minimum thickness of 4 μm in this case and, of course, both layers having to be made of the copolymers cited. This embodiment is especially favorable in regard to additives, since the particular additives may be selected independently for the covering layer and for the intermediate layer. For example, antiblocking agents may be added in a targeted way to the covering layer, where they effectively prevent blocking in small quantities.

Surprisingly, this measure improves the barrier of the opaque film significantly after metallization, although no special barrier properties could be detected at the non-metallized opaque film.

The metallized opaque films according to the present invention offer improved sealing properties over transparent metallized films and simultaneously—in spite of the vacuole-containing base layer—a very good barrier after metallization both in relation to water vapor and also in relation to oxygen. This film may therefore be used especially advantageously for manufacturing pouch packages for powdered bulk products which are sensitive to water vapor and oxygen.

The propylene copolymers used according to the present invention in the layer to be metallized, having a low ethylene content and a high melting point, are known per se and will also be referred to in the framework of the present invention as “minicopo” because of their comparatively low ethylene content. Thus, different teachings describe the advantageous use of these raw materials. For example, it is specified in EP 0 361 280 that this material is advantageous as a covering layer in films which may be metallized. DE 39 33 695 describes improved adhesion properties of these covering layers. However, it was neither known nor foreseeable that these special copolymers would have a favorable effect on the barrier properties after metallization as the covering layer on a vacuole-containing base layer if the layer thickness is at least 4 μm.

For the purposes of the present invention, propylene-ethylene copolymers having an ethylene content of 1.2 to 2.8 weight-percent, particularly 1.2 to 2.3 weight-percent, preferably 1.5 to <2 weight-percent, are especially preferred. The melting point is preferably in a range from 150 to 155° C. and the melting enthalpy is preferably in a range from 90 to 100 J/g. The melt flow index is generally 3 to 15 g/10 minutes, preferably 3 to 9 g/10 minutes (230° C., 21.6 N DIN 53 735). Furthermore, it is especially advantageous if a higher proportion of the ethylene units are incorporated into the propylene chain isolated between two propylene components. This characteristic may be described via a distribution factor, which is generally to be above 5, preferably above 10, particularly >15. Determining the distribution factor is described, for example, in DE 39 33 695 (page 2), reference hereby expressly being made thereto.

In general, the first covering layer contains at least 80 weight-percent, preferably 95 to 100 weight-percent, particularly 98 to <100 weight-percent of the described copolymers. In addition to this main component, the covering layer may contain typical additives such as antiblocking agents, stabilizers, and/or neutralization agents in the particular effective quantities. If necessary, small quantities of a second different polyolefin, preferably propylene polymers, may be contained if its proportion is below 20 weight-percent, preferably below 5 weight-percent, and the ability to metallize the layer is not impaired. Embodiments of this type are not preferred, but are conceivable if, for example, antiblocking agents are incorporated via concentrates which are based on a different polymer, such as propylene homopolymers or other propylene mixed polymers. In regard to the metallization, additives which impair the ability to be metallized should not be contained in the covering layer. This applies to migrating lubricants or antistatic agents, for example.

In a second embodiment according to the present invention, the metallizable layer is a combination of a first covering layer D and a first intermediate layer Z, which is attached between the first covering layer cited and the base layer B, i.e., one surface of this intermediate layer is bonded to the base layer and the second, diametrically opposite surface is bonded to the covering layer, according to a construction BZD.

For these embodiments, both layers, i.e., first covering layer and first intermediate layer, are synthesized from the same minicopo described above. Both layers each contain at least 80 weight-percent, preferably 95 to 100 weight-percent, particularly 98 to <100 weight-percent of the polymer, the precise composition of the individual layers not having to be identical, of course. These embodiments having a combination of intermediate layer and covering layer are advantageous in regard to possible different additives of the individual layers. Thus, for example, it is possible to add antiblocking agents only to the covering layer and keep the intermediate layer free of other additives. In general, however, both layers will contain stabilizers and neutralization agents. In particular, transparent intermediate layers which do not contain vacuole-containing fillers are preferred. TiO₂ may be added without significant technical disadvantages, although the higher degree of whiteness of the film thus achieved by the application would be recognizable, if at all, only as a whiter appearance of the interior after opening the pouch.

For the first embodiment described, the thickness of the first covering layer is generally at least 4 μ, preferably 5 to 10 μm. For embodiments having an intermediate layer, the specifications apply correspondingly for the total thickness of intermediate layer and covering layer, the thickness of the intermediate layer generally being at least 2.5 μm, preferably 4.5-8 μm, and the thickness of the covering layer generally being 0.5 to 4 μm, preferably 0.5 to 2 μm.

To improve the metal adhesion, the surface of the first covering layer is generally subjected in a way known per se to a method for elevating the surface tension using corona, flame, or plasma. Typically, the surface tension of the covering layer thus treated, which has not yet been metallized, is in a range from 35 to 45 mN/m.

The film according to the present invention is also distinguished by vacuoles in the base layer, which provide the film with an opaque appearance. “Opaque film” as defined in the present invention means an opaque film, whose light transmission (ASTM-D 1003-77) is at most 70%, preferably at most 50%.

The vacuole-containing base layer of the multilayer film contains polyolefin, preferably a propylene polymer, and vacuole-initiating fillers, as well as further typical additives as necessary in the particular effective quantities. In general, the base layer contains at least 70 weight-percent, preferably 75 to 98 weight-percent, particularly 85 to 95 weight-percent of the polyolefin, in relation to the weight of the layer in each case. In a further embodiment, the base layer may additionally contain pigments, particularly TiO₂.

Propylene polymers are preferred as the polyolefins of the base layer. These propylene polymers contain 90 to 100 weight-percent, preferably 95 to 100 weight-percent, particularly 98 to 100 weight-percent propylene units and have a melting point of 120° C. or higher, preferably 150 to 170° C., and generally have a melt flow index of 1 to 10 g/10 minutes, preferably 2 to 8 g/10 minutes, at 230° C. and a force of 21.6 N (DIN 53735). Isotactic propylene homopolymers having an atactic proportion of 15 weight-percent or less, copolymers of ethylene and propylene having an ethylene content of 5 weight-percent or less, copolymers of propylenes with C₄-C₈ olefins having an olefin content of 5 weight-percent or less, terpolymers of propylene, ethylene, and butylene having an ethylene content of 10 weight-percent or less and having a butylene content of 15 weight-percent or less are preferred propylene polymers for the base layer, isotactic propylene homopolymer being especially preferred. The weight-percents specified relate to the particular polymer.

Furthermore, a mixture of the cited propylene homopolymers and/or copolymers and/or terpolymers and other polyolefins, particularly made of monomers having 2 to 6 C atoms, is suitable, the mixture containing at least 50 weight-percent, particularly at least 75 weight-percent propylene polymer. Suitable other polyolefins in the polymer mixture are polyethylenes, particularly HDPE, MDPE, LDPE, VLDPE, and LLDPE, the proportion of these poly olefins not exceeding 15 weight-percent each, in relation to the polymer mixture.

The opaque base layer of the film generally contains vacuole-initiating fillers in a quantity of at most 30 weight-percent, preferably 2 to 25 weight-percent, particularly 2 to 15 weight-percent, in relation to the weight of the opaque base layer.

As defined in the present invention, vacuole-initiating fillers are solid particles which are incompatible with the polymer matrix and result in the formation of vacuole-like cavities when the film is stretched, the size, type, and number of the vacuoles being a function of the quantity and size of the solid particles and the stretching conditions such as the stretching ratio and stretching temperature. The vacuoles reduce the density and provide the films with a characteristic nacreous, opaque appearance, which arises due to light scattering at the boundaries “vacuole/polymer matrix”. The light scattering at the solid particles themselves generally contributes comparatively little to the opacity of the film. Typically, the vacuole-initiating fillers have a minimum size of 1 μm, in order to result in an effective, i.e., opaque-making quantity of vacuoles. In general, the average particle diameter of the particles is 1 to 6 μm, preferably 1 to 4 μm. The chemical character of the particles plays a subordinate role.

Typical vacuole-initiating fillers are inorganic and/or organic materials which are incompatible with polypropylene, such as aluminum oxide, aluminum sulfate, barium sulfate, calcium carbonate, magnesium carbonate, silicates such as aluminum silicate (kaolin clay) and magnesium silicate (talcum) and silicon dioxide, of which calcium carbonate and silicon dioxide are preferably used. The typically used polymers which are incompatible with the polymers of the base layer come into consideration as organic fillers, particularly copolymers of cyclic olefins (COC) as described in EP-A-0 623 463, polyesters, polystyrenes, polyamides, and halogenated organic polymers, with polyesters such as polybutylene terephthalate and cycloolefinic copolymers being preferred. Incompatible materials and/or incompatible polymers means, as defined in the present invention, that the material and/or the polymer exists in the film as separate particles and/or as a separate phase.

In a further embodiment, the base layer may additionally contain pigments, for example, in a quantity of 0.5 to 10 weight-percent, preferably 1 to 8 weight-percent, particularly 1 to 5 weight-percent. The specifications relate to the weight of the base layer.

As defined in the present invention, pigments are incompatible particles which essentially do not result in vacuole formation upon stretching of the film. The coloring effect of the pigments is caused by the particles themselves. The term “pigments” is generally connected to an average particle diameter in the range from 0.01 to at most 1 μm and includes both “white pigments”, which color the film white, and also “color pigments”, which provide the film with a colored or black color. In general, the average particle diameter of the pigments is in the range from 0.01 to 1 μm, preferably 0.01 to 0.7 μm, particularly 0.01 to 0.4 μm.

Typical pigments are materials such as aluminum oxide, aluminum sulfate, barium sulfate, calcium carbonate, magnesium carbonate, silicates such as aluminum silicate (kaolin clay) and magnesium silicate (talcum), silicon dioxide, and titanium dioxide, of which white pigments such as calcium carbonate, silicon dioxide, titanium dioxide, and barium sulfate are preferably used. Titanium dioxide is especially preferred. Various modifications and coatings of TiO₂ are known per se in the related art.

The density of the film is essentially determined by the density of the base layer. The density of the vacuole-containing base layer is generally reduced by the vacuoles, if larger quantities of TiO₂ do not compensate for the density-reducing effect of the vacuoles. In general, the density of the opaque base layer is in a range from 0.45-0.85 g/cm³. The density of the film may vary in a wide range for the white-opaque embodiments described and is generally in a range from 0.5 to 0.95 g/cm³, preferably 0.6 to 0.9 g/cm³. The density is elevated in principle by adding TiO₂, but simultaneously reduced by the vacuole-initiating fillers in the base layer. For a base layer which does not contain any density-elevating TiO₂, the density of the opaque base layer is preferably in a range from 0.45 to 0.75 g/cm³, while in contrast the range from 0.6 to 0.9 g/cm³ is preferred for the white-opaque base layer.

The total thickness of the film is generally in a range from 20 to 100 μm, preferably 25 to 60 μm, particularly 30 to 50 μm. The thickness of the base layer is. correspondingly 10 to 50 μm, preferably 10 to 40 μm.

In a further preferred embodiment, the film includes even further layers, which are applied to the diametrically opposite side of the base layer. Through a second covering layer, three-layer or four-layer films result. Embodiments which additionally have a second intermediate layer and a second covering layer applied thereto result in four-layer or five-layer films. In these embodiments, the thickness of the second covering layer is generally 0.5-3 μm, intermediate layers are in the range from 1 to 8 μm.

Combinations made of intermediate layer and covering layer advantageously have a total thickness of 2 to 8 μm. Sealable layers are preferred as further layers, both layers which may be hot sealed and those which may be cold sealed being understood here. Cold seal coatings may also be applied directly to the surface of the base layer. In general, however, it is preferable to first cover the base layer with the polymer covering layer and apply the cold seal coating to this polymer covering layer.

The additional layer or layers generally contain at least 80 weight-percent, preferably 90 to <100 weight-percent olefinic polymers or mixtures thereof. Suitable polyolefins are, for example, polyethylenes, propylene copolymers, and/or propylene terpolymers, as well as the propylene homopolymers already described in connection with the base layer.

Suitable propylene copolymers or terpolymers are generally synthesized from at least 50 weight-percent propylene and ethylene and/or butylene units as the comonomers. Preferred mixed polymers are random ethylene-propylene copolymers having an ethylene content of 2 to 10 weight-percent, preferably 5 to 8 weight-percent, or random propylene-butylene-1 copolymers, having a butylene content of 4 to “25 weight-percent, preferably 10 to 20 weight-percent, each in relation to the total weight of the copolymers, or random ethylene-propylene-butylene-1 terpolymers, having an ethylene content of 1 to 10 weight-percent, preferably 2 to 6 weight-percent, and a butylene-1 content of 3 to 20 weight-percent, preferably 8 to 10 weight-percent, each in relation to the total weight of the terpolymers. These copolymers and terpolymers generally have a melt flow index of 3 to 15 g/10 minutes, preferably 3 to 9 g/10 minutes (230° C., 21.6 N DIN 53735) and a melting point of 70 to 145° C., preferably 90 to 140° C. (DSC).

Suitable polyethylenes are, for example, HDPE, MDPE, LDPE, VLDPE, and LLDPE, of which HDPE and MDPE types are especially preferred. The HDPE generally has an MFI (50 N/190° C.) of >0.1 to 50 g/10 minutes, preferably 0.6 to 20 g/10 minutes, measured according to DIN 53 735, and a coefficient of viscosity, measured according to DIN 53728, part 4, or ISO 1191, in the range from 100 to 450 cm³/g, preferably 120 to 280 cm³/g. The crystallinity is 35 to 80%, preferably 50 to 80%. The density, measured at 230C according to DIN 53 479, method A, or ISO 1183, is in the range from >0.94 to 0.96 g/cm³. The melting point, measured using DSC (maximum of the melting curve, heating speed 20° C./minute), is between 120 and 140° C. Suitable MDPE generally has an MFI (50 N/190° C.) of >0.1 to 50 g/10 minutes, preferably 0.6 to 20 g/10 minutes, measured according to DIN 53 735. The density, measured at 23° C. according to DIN 53 479, method A, or ISO 1183, is in the range from >0.925 to 0.94 g/cm³. The melting point, measured using DSC (maximum of the melting curve, heating speed 20° C./minute), is between 115 and 130° C.

In regard to the use of the film as a pouch package for powdered bulk products, a mixture made of the described propylene copolymers and/or terpolymers and the cited polyethylenes is especially preferred for the second covering layer and, if necessary, for the second intermediate layer. These covering layer mixtures are especially advantageous in regard to the sealing properties of the film if the pouch is used for packaging powdered bulk products. Using the current methods for packaging powders, contamination of the seal regions may not be effectively prevented. These contaminations frequently result in problems during sealing. The seal seams have reduced or even no strength in the contaminated regions, and the tightness of the seal seam is also impaired. Surprisingly, the contaminations interfere only slightly or not at all during sealing if the seal layers are synthesized from a mixture of propylene polymers and polyethylenes. Covering layer mixtures which contain HDPE and/or MDPE, having an HDPE or MDPE proportion of 10 to 50 weight-percent, particularly 15 to 40 weight-percent, are especially advantageous for this purpose. For these especially advantageous applications, the layer thickness of the second covering layer, and/or the total thickness of second intermediate layer and second covering layer is to be at least 4 μm, preferably 4 to 8 μm, particularly 4 to 6 μm.

It is suspected that the compressibility of the vacuole-containing base layer works together synergistically with the special covering layer mixture made of propylene mixed polymer and HDPE or MDPE. It has been found that a covering layer mixture of this type has comparatively worse sealing properties on a transparent base layer.

As already noted, all layers of the film preferably contain neutralization agents and stabilizers in the particular effective quantities.

The typical stabilizing compounds for ethylene, propylene, and other olefin polymers may be used as stabilizers. The quantity added is between 0.05 and 2 weight-percent. Phenolic stabilizers, alkaline/alkaline earth stearates, and alkaline/alkaline earth carbonates are especially suitable. Phenolic stabilizers are preferred in a quantity of 0.1 to 0.6 weight-percent, particularly 0.15 to 0.3 weight-percent, and having a molar mass of more than 500 g/mol. Pentaerythrityl-tetrakis-3-(3,5-di-tertiary butyl-4-hydroxyphenyl)-propionate or 1,3,5-trimethyl-2,4,6-tris(3,5-di-tertiary butyl-4-hydroxybenzyl)benzene are especially advantageous.

Neutralization agents are preferably calcium stearate, and/or calcium carbonate and/or synthetic dihydrotalcite (SHYT) of an average particle size of at most 0.7 μm, an absolute particle size of less than 10 μm, and a specific surface area of at least 40 m²/g. In general, neutralization agents are used in a quantity of 50 to 1000 ppm, in relation to the layer.

In a preferred embodiment, antiblocking agents are added to both the covering layer to be metallized and also the diametrically opposite covering layer.

Suitable antiblocking agents are inorganic additives such as silicon dioxide, calcium carbonate, magnesium silicate, aluminum silicate, calcium phosphate, and the like, and/or incompatible polymers such as polymethyl methacrylate (PMMA) polyamides, polyesters, polycarbonates, with polymethyl methacrylate (PMMA), silicon dioxide, and carbon dioxide being preferred. The effective quantity of antiblocking agent is in the range from 0.1 to 2 weight-percent, preferably 0.1 to 0.5 weight-percent, in relation to the particular covering layer. The average particle size is between 1 and 6 μm, particularly 2 and 5 μm, particles having a spherical shape, as described in EP-A-0 236 945 and DE-A-38 01 535, being especially suitable.

Furthermore, the present invention relates to methods for manufacturing the multilayer film according to the present invention according to coextrusion methods known per se, the tentering method being particularly preferred.

In the course of this method, the melts corresponding to the individual layers of the film are coextruded through a sheet die, the film thus obtained is drawn off to solidify on one or more roll(s), the film is subsequently stretched (oriented), and the stretched film is thermally fixed and possibly plasma, corona, or flame treated on the surface layer provided for treatment.

Specifically, for this purpose, as is typical in the extrusion methods, the polymers and/or the polymer mixture of the individual layers is compressed in an extruder and liquefied, the vacuole-initiating fillers and other possibly added additives already being able to be contained in the polymer and/or in the polymer mixture. Alternatively, these additives may also be incorporated via a masterbatch.

The melts are then pressed jointly and simultaneously through a sheet die, and the multilayered film extruded is drawn off on one or more draw-off rolls at a temperature of 5 to 100° C., preferably 10 to 50° C., so that it cools and solidifies.

The film thus obtained is then stretched longitudinally and transversely to the extrusion direction, which results in orientation of the molecular chains. The longitudinal stretching is preferably performed at a temperature of 80 to 150° C., expediently with the aid of two rolls running at different speeds in accordance with the stretching ratio desired, and the transverse stretching is preferably performed at a temperature of 120 to 170° C. with the aid of a corresponding tenter frame. The longitudinal stretching ratios are in the range from 4 to 8, preferably 4.5 to 6. The transverse stretching ratios are the range from 5 to 10, preferably 7 to 9.

The stretching of the film is followed by its thermal fixing (heat treatment), the film being held approximately 0.1 to 10 seconds long at a temperature of 100 to 160° C. Subsequently, the film is wound up in a typical way using a winding device.

Preferably, after the biaxial stretching, one or both surfaces of the film is/are plasma, corona, or flame treated according to one of the known methods. The treatment intensity is generally in the range from 35 to 50 mN/m, preferably 37 to 45 mN/m, particularly 39 to 40 mN/m.

For the corona treatment, the film is guided between two conductor elements used as electrodes, such a high voltage being applied between the electrodes, usually alternating voltage (approximately 10,000 V and 10,000 Hz), that spray or corona discharges may occur. Through the spray or corona discharge, the air above the film surface is ionized and reacts with the molecules of the film surface, so that polar intercalations arise in the essentially nonpolar polymer matrix. The treatment intensities are within the typical scope, 37 to 45 mN/m being preferred.

The coextruded multilayered film is provided on the outer surface of the first covering layer with a metal coating, preferably made of aluminum, according to methods known per se. This metallization is performed in a vacuum chamber in which aluminum is vaporized and deposited on the film surface. In a preferred embodiment, the surface to be metallized is subjected to plasma treatment directly before the metallization.

The thickness of the metal coating generally correlates with the optical density of the metallized film, i.e., the thicker the metal coating is, the higher the optical density of the metallized film. In general, the optical density of the metallized film according to the present invention is to be at least 2, particularly 2.5 to 4. The film thus metallized may be used directly for manufacturing pouch packages, such as for packages of mashed potato flakes, coffee powder, etc.

The opaque film according to the present invention is distinguished by outstanding barrier values, which have not been implemented previously for opaque films. The water vapor permeability of the opaque metallized film according to the present invention is generally ≦0.5 g/m²*day at 38° C. and 90% relative ambient humidity, preferably in a range from 0.05 to 0.3 g/m²*day. The oxygen permeability is preferably ≦50 cm³/m²*day*bar, preferably 5 to 30 cm³/m²*day*bar, particularly 5 to 25 cm³/m²*day*bar.

In a preferred embodiment of the package, the metallized film according to the present invention is laminated with a further biaxially oriented film, the lamination being performed against the metallized side of the metallized film. The further boPP film is preferably printed, so that the pouch package has an attractive appearance. In principle, transparent or even opaque boPP films may be used for the further film. Preferably, the metallized film is laminated against an opaque multilayered boPP film which has a vacuole-containing base layer and a printable covering layer. For example, four-layer films having a covering layer on a surface of the base layer which is suitable for lamination against the metal coating and a combination of homopolymer intermediate layer, which is possibly modified using TiO₂, and printable covering layer on the diametrically opposite surface of the base layer attached thereto are suitable. These laminates are distinguished by especially appealing surface gloss of the finished, printed laminate.

The following measurement methods were used to characterize the raw materials and the films:

Melt-Flow Index

The melt-flow index was measured according to DIN 53735 at 21.6 N load and 230° C.

Water Vapor and Oxygen Permeability

The water vapor permeability was determined in accordance with DIN 53122 part 2. The oxygen barrier effect was determined in accordance with the draft of DIN 53380 part 3 at an ambient humidity of approximately 50%.

Determination of the Ethylene Content

The ethylene content of the copolymer was determined using ¹³C NMR spectroscopy. The measurements were performed using an atomic resonance spectrometer from Bruker Avance 360. The copolymer to be characterized was dissolved in tetrachloroethane, so that a 10% mixture resulted. Octamethyl tetrasiloxane (OTMS) was added as a reference standard. The atomic resonance spectrum was measured at 120° C. The spectra were analyzed as described in J. C. Randall Polymer Sequence Distribution (Academic Press, New York, 1977).

Melting Point and Melting Enthalpy

The melting point and the melting enthalpy were determined using DSC (differential scanning calorimetry) measurement (DIN 51 007 and DIN 53 765). Several milligrams (3 to 5 mg) of the raw material to be characterized were heated in a differential calorimeter at a heating speed of 20° C. per minute. The thermal flux was plotted against the temperature and the melting point was determined as the maximum of the melting curve and the melting enthalpy was determined as the area of the particular melting peak.

Density

The density was determined according to DIN 53 479, method A.

Surface Tension

The surface tension was determined via the ink method according to DIN 53364.

Optical Density

The optical density is the measurement of the transmission of a defined light beam. The measurement was performed using a densitometer of the type TCX from Tobias Associates Inc. The optical density is a relative value which is specified without a dimension.

The present invention will now be explained through the following examples.

### EXAMPLE 1

A three-layer precursor film was extruded according to the coextrusion method from a sheet die at 240 to 270° C. This precursor film was first drawn off on a cooling roll and cooled. Subsequently, the precursor film was oriented in the longitudinal and transverse directions and finally fixed. The surface of the first covering layer was pretreated using corona to elevate the surface tension. The three-layer film had a layer structure of first covering layer/base layer/second covering layer. The individual layers of the film had the following composition:

First Covering Layer (5.0 μm):
99.87 weight-percent ethylene-propylene copolymer having an ethylene component of 1.7 weight-percent (in relation to the copolymer) and a melting point of 155° C.; and a melt flow index of 8.5 g/10 minutes at 230° C. and 2.16 kg load (DIN 53 735) and a melting enthalpy of 96.9 J/g
0.13 weight-percent polymethyl methacrylate (PMMA)

Base Layer:
91.3 weight-percent propylene homopolymer (PP) having an n-heptane-soluble component of approximately 4 weight-percent (in relation to 100% PP) and a melting point of 163° C.; and a melt flow index of 3.3 g/10 minutes at 230° C. and 2.16 kg load (DIN 53 735) and
4.0 weight-percent calcium carbonate having an average particle diameter of 1.4 μm
4.7 weight-percent titanium dioxide having an average particle diameter of 0.1 to 0.3 μm

Second Covering Layer (2.0 μm):
99.7 weight-percent ethylene-propylene copolymer having an ethylene component of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g
0.3 weight-percent antiblocking agent having an average particle diameter of approximately 4 μm (Sylobloc 45)

All layers of the film additionally contain stabilizers and neutralization agents in typical quantities.

Specifically, the following conditions and temperatures were selected when manufacturing the film:
extrusion: extrusion temperature approx. 250-270° C.
cooling roll: temperature 30° C.
longitudinal stretching: T=125° C.
longitudinal stretching by a factor of 5
transverse stretching: T=165° C.
transverse stretching by a factor of 9
fixing: T=143° C.

The film was surface treated on the surface of the first covering layer using corona and has a surface tension of 38 mN/m. The film has a thickness of 40 μm and an opaque appearance.

### EXAMPLE 2

An opaque film was manufactured according to example 1. In contrast to example 1, the composition of the second covering layer was altered and a second intermediate layer was introduced:

Second Covering Layer (2 μm)
65 weight-percent ethylene-propylene copolymer having an ethylene component of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g
34.8 weight-percent polyethylene having a density of 0.93 g/cm³ and a melt flow index of (190° C. and 50 N) 0.8 g/10 minutes
0.2 weight-percent antiblocking agent having an average particle diameter of approximately 4 μm (Sylobloc 45)

Second Intermediate Layer (3 μm)
65 weight-percent ethylene-propylene copolymer having an ethylene component of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g
34.8 weight-percent polyethylene having a density of 0.93 g/cm³ and a melt flow index (190° C. and 50 N) of 0.8 g/10 minutes
0.2 weight-percent antiblocking agent having an average particle diameter of approximately 4 μm (Sylobloc 45)

The total thickness of second covering layer and second intermediate layer was 5 μm.

### EXAMPLE 3

An opaque film was manufactured according to example 2. In contrast to example 2, a first intermediate layer having a thickness of 4 μm was introduced between the base layer and the first covering layer. In addition, the thickness of the first covering layer was reduced from 5 μm to 1.5 μm, so that a total thickness of first covering layer and first intermediate layer of 5.5 μm resulted:

First Intermediate Layer (4 μm):
100 weight-percent ethylene-propylene copolymer having an ethylene component of 1.7 weight-percent (in relation to the copolymer) and a melting point of 155° C.; and a melt flow index of 8.5 g/10 minutes at 230° C. and 2.16 kg load (DIN 53 735) and a melting enthalpy of 96.9 J/g

### COMPARATIVE EXAMPLE 1

An opaque film was manufactured according to example 1. In contrast to example 1, the thickness of the first covering layer was only 0.5 μm. The total thickness of the film was 40 μm.

### COMPARATIVE EXAMPLE 2

An opaque film was manufactured according to example 1. In contrast to example 1, the thickness of the first covering layer was reduced from 5 μm to 1 μm and a first intermediate layer of 4 μm made of propylene homopolymer was incorporated:

First Intermediate Layer (4 μm):
100 weight-percent propylene homopolymer (PP) having an n-heptane-soluble component of 3.3 weight-percent (in relation to 100% PP) and a melting point of 161° C.; and a melt flow index of 2.9 g/10 minutes at 230° C. and 2.16 kg load (DIN 53 735)

First Covering Layer (1 μm):
99.7 weight-percent ethylene-propylene copolymer having an ethylene component of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g
0.3 weight-percent antiblocking agent having an average particle diameter of approximately 4 μm (Sylobloc 45)

### COMPARATIVE EXAMPLE 3

A film was manufactured as described in comparative example 2. In contrast to comparative example 2, the composition of the first covering layer was changed:

First Covering Layer (1 μm):
99.87 weight-percent ethylene-propylene copolymer having an ethylene component of 1.7 weight-percent (in relation to the copolymer) and a melting point of 155° C.; and a melt flow index of 8.5 g/10 minutes at 230° C. and 2.16 kg load (DIN 53 735) and a melting enthalpy of 96.9 J/g
0.13 weight-percent polymethyl methacrylate (PMMA).

### COMPARATIVE EXAMPLE 4

A film was manufactured according to example 1, in contrast to example 1, the thickness of the first covering layer was only 0.5 μm. In addition, the composition of the base layer was changed.

Base layer:
100 weight-percent propylene homopolymer (PP) having an n-heptane-soluble component of 3.3 weight-percent (in relation to 100% PP) and a melting point of 161° C.; and a melt flow index of 2.9 g/10 minutes at 230° C. and 2.16 kg load (DIN 53 735)

The film was a total of 35 μm thick. In contrast to example 1, this film was transparent.

### COMPARATIVE EXAMPLE 5

A film was manufactured as described in comparative example 2. In contrast to comparative example 2, the intermediate layer was left out. In addition, the composition of the base layer was changed:

Base Layer:
100 weight-percent propylene homopolymer (PP) having an n-heptane-soluble component of 3.3 weight-percent (in relation to 100% PP) and a melting point of 161° C.; and a melt flow index of 2.9 g/10 minutes at 230° C. and 2.16 kg load (DIN 53 735)

The film was a total of 35 μm thick. In contrast to example 2, this film was transparent.

All films according to the examples and the comparative examples were coated with an aluminum coating in a vacuum metallizing facility. To improve the metal adhesion, the surface was subjected to a plasma treatment directly before the coating. The properties of the metallized films according to the examples in the comparative examples are summarized in Table 1. It has been shown that the films according to the present invention according to examples 1, 2, and 3 have outstanding barrier values against water vapor and oxygen and, simultaneously, good sealing properties in spite of contamination when used as pouch packages for powdered bulk products.

| | | Density | Sealing** | | OTR 23° C., |
|---|---|---|---|---|---|
| | | of the | at 130° C. | WDD 38° C. | 50% |
| | Thickness | film | 10 N, 0.5 | 90% relative | relative |
| Example | μm | g/cm³ | seconds | humidity*** | humidity*** |
| Example | 40 | 0.71 | + | <0.2 | <20 |
| 1 | | | | | |
| Example | 40 | 0.71 | ++ | <0.2 | <20 |
| 2 | | | | | |
| Example | 40 | 0.71 | ++ | <0.2 | <20 |
| 3 | | | | | |
| CE 1 | 40 | 0.71 | + | >0.8 | >100 |
| CE 2 | 40 | 0.71 | + | ˜0.5 | >100 |
| CE 3 | 40 | 0.71 | + | ˜0.15 | 9 |
| CE 4 | 35 | 0.91 | − | >0.2 | >20 |
| CE 5 | 35 | 0.91 | − | >0.2 | ˜60 |

**sealing of the non-metallized second covering layer against itself
***after metallization

1. A metallized, biaxially oriented opaque polypropylene multilayer film having at least three layers including a base layer and at least one first metallized covering layer on one surface of the base layer and a second sealable covering layer on the diametrically opposite side, characterized in that the first covering layer contains at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g and the first covering layer has a thickness of at least 4 μm and the film is metallized on the surface of the first covering layer and the base layer contains vacuoles.

2. A metallized, biaxially oriented opaque polypropylene multilayer film having at least four layers including a base layer and at least one first intermediate layer and a first covering layer and a second sealable covering layer on the diametrically opposite side, characterized in that the first covering layer and the first intermediate layer lie one on top of another and each contain at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g and the total thickness of the first covering layer and the first intermediate layer is at least 4 μm and the film is metallized on the surface of the first covering layer and the base layer contains vacuoles.

3. The film according to claim 1, characterized in that the propylene-ethylene copolymer contains 1.5 to 2.3 weight-percent ethylene and has a melting point in the range from 150 to 155° C. and a melting enthalpy of 90 to 100 J/g.

4. The film according to claim 1, characterized in that the optical density of the metal coating is at least 2.5.

5. The film according to claim 1, characterized in that the base layer is synthesized from propylene homopolymer and contains 2 to 25 weight-percent vacuole-initiating fillers.

6. The film according to claim 1, characterized in that the second sealable covering layer contains at least 80 to <100 weight-percent of a propylene polymer having at least 80 weight-percent propylene units.

7. The film according to claim 1, characterized in that the second covering layer contains at least 80 to <100 weight-percent of a polymer mixture, the mixture comprising propylene polymers having at least 80 weight-percent propylene units and polyethylene and the mixture containing 10 to 50 weight-percent of the polyethylene in relation to the weight of the mixture.

8. The film according to claim 7, characterized in that the polyethylene is an HDPE or MDPE.

9. The film according to claim 1, characterized in that the second covering layer contains an antiblocking agent.

10. A method for manufacturing a film according to claim 1, characterized in that the polyolefinic layers are coextruded.

11. The method according to claims 10, characterized in that the film is pretreated on the surface of the first covering layer during the film manufacturing using corona, flame, or plasma.

12. The method according to claim 1 1, characterized in that the surface to be metallized is treated using plasma directly before the metallization.

13. A pouch package which comprises the film according to claim 1.

14. The pouch package according to claim 13, characterized in that the pouch package is manufactured by sealing all four edges.

15-19. (canceled)

20. The pouch package according to claim 13, which further comprises a powdered bulk product being in the pouch package.

21. A process for manufacturing a laminate which comprises laminating the film according to claim 1 with a further biaxially oriented polypropylene film.

22. The process according to claim 21, characterized in that the metallized film is laminated with the metallized side against a second boPP film.

23. The process according to claim 22, characterized in that the second boPP film of the laminate has an opaque base layer.

24. The process according to claim 22, characterized in that the further biaxially oriented polypropylene film is printed.

25. The film according to claim 5, characterized in that the second sealable covering layer contains at least 80 to <100 weight-percent of a propylene polymer having propylene copolymers and/or propylene terpolymers having a propylene content of at least 90 to 97 weight-percent.
